(19) United States
(12) Patent Application Publication
(10) Pub. No.: US 2025/0042692 A1
(43) Pub. Date: Feb. 6, 2025

(54) ELEVATOR SYSTEM WITH OPERATION OF ELEVATOR CALLS ADAPTED TO MIXED-USE BUILDINGS

(71) Applicant: Inventio AG, Hergiswil (CH)

(72) Inventors: Lukas Finschi, Ebikon (CH); Florian Trösch, Erlenbach ZH (CH)

(21) Appl. No.: 18/716,471

(22) PCT Filed: Nov. 29, 2022
(86) PCT No.: PCT/EP2022/083634

§ 371 Date: Jun. 4, 2024

(30) Foreign Application Priority Data
Dec. 22, 2021 (EP) 21216710.0

(51) Int. Cl. B66B 1/28; B66B 1/24; B66B 1/34; B66B 1/46; B66B 13/14

(52) U.S. Cl. CPC B66B 1/28; B66B 1/2416; B66B 1/3407; B66B 1/468; B66B 13/146; B66B 2201/101; B66B 2201/103; B66B 2201/21; B66B 2201/214; B66B 2201/403; B66B 2201/405; B66B 2201/4615; B66B 2201/4661

(57) ABSTRACT

An elevator system for a building comprises an elevator controller and an elevator car movable in an elevator shaft. At least one first floor or first floor area for a first user group and at least one second floor or second floor area for a second user group are defined in the building. A memory device saves this definition and an operating mode assigned thereto for each user group. During operation, a first elevator call is received and analyzed by the elevator controller to determine a first call input floor and/or a first destination floor. An operating mode is ascertained based on the first call input floor and/or the first destination floor. According to this operating mode, the elevator car is controlled by the elevator controller.

### TECHNICAL FIELD

The present disclosure relates in general to an elevator system in a building. Exemplary embodiments of the disclosure relate in particular to a way of servicing elevator calls in the elevator system and a method for operating such an elevator system.

### SUMMARY

Buildings are usually designed and constructed for a single use or for mixed use. A residential building is an example of a single use, as is an office building. A mixed use exists if, for example, a building comprises apartments and commercially used space. An elevator system installed in the building is adapted for the respective type of use. Depending on the building, the elevator system can have a single elevator, an elevator group or a plurality of elevator groups; in addition, one or more special elevators (e.g., freight elevators) can be provided.

Over time, the originally planned use of the building can change for various reasons. The need for office space or commercial space in general may decline due to changing life and work circumstances, for example. In an office building, for example, vacant space on one or more floors can be converted into apartments. In the event of such a change of use, the elevator system installed in the building remains substantially as it was adapted for the originally planned use of the building.

U.S. Pat. No. 7,823,700 B2 describes an elevator system in which users are identified on the basis of transponders carried by them and assigned to one of several user classes. Priority levels are assigned to the user classes, wherein a higher priority level is addressed before a lower priority level.

Although an elevator system is still available for transporting persons and goods after a change of use, it may be necessary or desirable, depending on the building and its use, for the elevator system to be adaptable to the changed use. There is therefore a need for a technology that fully or at least partially meets these requirements.

One aspect of the disclosure described herein relates to a method for operating an elevator system in a building which can comprise at least a first floor or at least a second floor area for a first user group, and at least a second floor or at least a second floor area for a second user group. This definition and the operating mode assigned to each user group can be saved in a memory device. The elevator system can have an elevator controller and an elevator car that can be moved in an elevator shaft. According to the method, a first elevator call may be received by the elevator controller and analyzed thereby to determine a first call input floor and/or a first destination floor based on the first elevator call. An operating mode may be ascertained based on the first call input floor and/or the first destination floor. The elevator controller may read the corresponding data from the memory device to determine the operating mode. The elevator controller can control the elevator car according to the ascertained operating mode.

A further aspect relates to an elevator system that can have an elevator controller and an elevator car which can be moved between floors of a building in an elevator shaft under the control of the elevator controller. At least one first floor or at least one first floor area for a first user group and at least one second floor or at least one second floor area for a second user group can be defined in the building. The definition and an operating mode assigned to each user group can be saved in a memory device. The elevator controller can be designed to control the elevator system in accordance with the method and its embodiments described herein.

According to the disclosure described here, an elevator system can be created in which user groups are recognized and differentiated on the basis of the floor to which an elevator is called as a boarding floor (also called a call input floor) and/or as an exit floor (also called a destination floor). It can thereby be ascertained, for example, where a passenger is located when the call is entered (e.g., on which floor or floor area) and/or which destination floor the passenger has. This can be used to determine the operating mode according to which the elevator system operates the elevator call. This can also result in the user group to which the passenger is assigned; the ascertained operating mode can be defined for this user group. The elevator call can then be operated specifically for user groups according to the ascertained operating mode. For example, elevator calls that are entered by residents on residential floors can be operated more slowly than elevator calls that are entered on commercially used floors. Such slower operation can result, for example, from a longer waiting time for an elevator car ready for boarding or a lower operating speed (e.g., travel speed or acceleration) of the elevator car.

In one exemplary embodiment, each operating mode can have at least one operating parameter. The at least one operating parameter can specify a priority level, a call assignment criterion or a speed variable, wherein the speed variable specifies a car travel speed, a car acceleration, a car deceleration, an opening and closing speed of a car door and a hold-open time of the car door. A first operating mode may differ from a second operating mode in terms of at least one operating parameter. The first operating mode which is assigned to a first user group, for example, therefore can differ in terms of at least one operating parameter from the second operating mode which is assigned to a second user group. The elevator controller therefore can have a different operating mode depending on the user group.

In one exemplary embodiment which may be applicable in conjunction with one or more of the preceding exemplary embodiments, a priority level can be defined for an operating mode, wherein the at least one operating parameter defines the priority level. The elevator controller can determine a first priority level which is defined by the at least one operating parameter of the determined first operating mode. The elevator controller can read corresponding data from the memory device to determine the first priority level. The elevator controller can check whether there is a second elevator call and, if this is the case, analyze the second elevator call in order to determine a second call input floor and/or a second destination floor from the second elevator call. Based on the second call input floor and/or the second destination floor, a second operating mode and a second priority level, which is determined by the at least one operating parameter of the second operating mode, can be determined. The elevator controller can read corresponding data from the memory device to determine the second operating mode and the second priority level. The operating mode that has priority over the other operating mode according to the priority level ascertained for it can be ascertained from the first operating mode and the second operating mode. The elevator controller can control the elevator car according to the ascertained priority operating mode, wherein the elevator call on which this operating mode is based is serviced with priority. The elevator controller can therefore be designed to take another factor into account when servicing elevator calls; it can therefore, for example, preferentially service an elevator call that is entered on a commercially used floor. Priority servicing means, for example, that if there are several calls to be serviced, the call entered on a commercial floor can be serviced before a call entered on a residential floor.

In one exemplary embodiment which may be applicable in conjunction with one or more of the preceding exemplary embodiments, a traffic threshold and a speed variable can be defined as operating parameters for an operating mode. The elevator controller can determine a current traffic volume in the elevator system, which can be compared with the traffic threshold of the ascertained operating mode that results from the ascertained first call input floor and/or the first destination floor. An initial speed variable can be defined for the ascertained operating mode. If the traffic threshold of the ascertained operating mode is undershot which indicates a low traffic volume, it can be ascertained whether a slower operation of the elevator car is defined for the ascertained determined operating mode compared to another operating mode defined in the elevator system. If this is the case, an alternative operating mode may be selected for which a second speed variable is defined, which accelerates operation of the elevator car compared to the first speed variable. The elevator car can be controlled according to the alternative operating mode. If this is not the case, the elevator car can be controlled according to the ascertained operating mode. The elevator controller can therefore be designed to use an additional factor in the response to elevator calls according to this exemplary embodiment. The operating mode can be determined not only on the basis of the ascertained first call input floor and/or the first destination floor, but also as a function of the traffic volume. For example, it may not be necessary or desirable to more slowly service elevator calls from residents or to give preference to elevator calls from commercial users when traffic volumes are low.

In one exemplary embodiment, which may be applicable in conjunction with one or more of the exemplary embodiments described herein, a service time limit and a call assignment criterion can be defined as operating parameters for an operating mode. The elevator controller can determine a current service time for servicing an elevator call in the elevator system, which can be compared with the service time threshold of the ascertained operating mode which results from the ascertained first call input floor and/or the first destination floor. An initial call assignment criterion can be defined for the ascertained operating mode. Exceeding the service time threshold of the ascertained operating mode can indicate an increased service time, in particular an increased waiting time. If the service time threshold is exceeded, it can be ascertained whether a longer service time for servicing an elevator call is defined for the ascertained operating mode compared to another operating mode defined in the elevator system. If this is the case, an alternative operating mode can be selected for which a second call assignment criterion is defined, and the elevator car may be controlled according to the alternative operating mode. The second call assignment criterion can reduce the service time for servicing an elevator call compared to the first service time. If this is not the case, the elevator car may be controlled according to the ascertained operating mode.

The elevator controller can therefore designed to use an additional factor in the response to elevator calls according to this exemplary embodiment. The operating mode can be ascertained not only on the basis of the ascertained first call input floor and/or the first destination floor, but also as a function of the service time. For example, there may be a situation in which it takes longer for a car to be ready for boarding; this may be the case, for example, if there is a high volume of traffic. For reasons of acceptance and convenience, however, the waiting time may be limited, especially in connection with an elevator call that a resident enters for a trip to or from an apartment floor. If such an elevator call exists and the corresponding operating mode results in a waiting time that is longer than that for an elevator call from a commercial floor, the alternative operating mode can aim to reduce the waiting time. The call assignment criterion can be defined in such a way that a call assignment algorithm optimizes the waiting time, e.g., reduces it.

In one exemplary embodiment which can be applicable in conjunction with one or more of the preceding exemplary embodiments, at least one validity period can be saved in the memory device for an operating mode. The validity period can determine when the operating mode is to be used. The elevator controller can check whether a received elevator call falls within a validity period of an ascertained operating mode. If this is the case, the elevator controller can control the elevator car according to the ascertained operating mode, and if this is not the case, the elevator controller can control the elevator car according to a standard mode. The elevator controller can therefore be designed to take another factor into account when servicing elevator calls.

In one exemplary embodiment, which may be applicable in conjunction with one or more of the preceding exemplary embodiments, the validity period can comprise at least one day of the week, at least one time of the day, and/or at least one period of the day. The elevator controller can therefore be adapted inter alia to the building and its use (e.g., the composition of the user groups).

In one exemplary embodiment, which may be applicable in conjunction with one or more of the exemplary embodiments described herein, a user group to which a passenger who initiates an elevator call is assigned can be ascertained based on the first call input floor and/or the first destination floor. The elevator controller can also be adapted inter alia to the building and its use (e.g., the composition of the user groups). In addition, the elevator controller can operate the elevator system specifically for user groups, e.g., commercial user groups can be served more quickly and/or preferentially.

In an exemplary embodiment which may be applicable in conjunction with one or more of the exemplary embodiments described herein, the first elevator call can be temporally operated differently by the elevator controller; in particular it can be operated at different speeds depending on whether the first or the second operating mode and the associated user groups are ascertained. In the aforementioned example, the elevator call of the resident can be serviced more slowly than the elevator call of a person from the commercial user group.

The disclosure described herein is not limited to a specific control technology; it can be used in an elevator system with a destination call controller and in an elevator system with a conventional up/down direction controller. In one exemplary embodiment which may be applicable in conjunction with one or more of the exemplary embodiments described herein, the first elevator call can be a destination call initiated by the first passenger outside the elevator car, wherein the elevator controller determines the first call input floor and the first destination floor from the destination call. This exemplary embodiment concerns an elevator system with a destination call controller.

In one exemplary embodiment, which may be applicable in conjunction with one or more of the exemplary embodiments described herein, the first elevator call can be a floor call initiated by the first passenger outside the elevator car that indicates a desired direction of travel, wherein the elevator controller ascertains the first call input floor from the floor call. The first elevator call can also be a car call initiated by the first passenger in the elevator car, wherein the elevator controller ascertains the first destination floor from the car call. This exemplary embodiment concerns an elevator system with a conventional up/down direction controller.

In the disclosure described herein, according to one or more of the exemplary embodiments described herein, an elevator call can be made with a permanently installed elevator operating device or with a mobile apparatus. The mobile apparatus can be, for example, a (card-like) credential with (RFID) radio technology or an optical code (e.g., QR code), or a cell phone with a corresponding software application, in certain circumstances in conjunction with Bluetooth technology or an optical code. The disclosure described here is also particularly applicable when an elevator call is made with such a mobile apparatus, namely without identifying the passenger, because even then the user group can be ascertained with the information relating to the boarding and exiting floor. For example, if passengers want to travel from an access floor (e.g., first floor) to an upper floor, the user group can distinguish the destination floor (exit floor).

### BRIEF DESCRIPTION OF THE DRAWINGS

Various aspects of the present disclosure are described in greater detail below in conjunction with the drawings with reference to exemplary embodiments. In the figures, identical elements have identical reference signs. In the drawings:

FIG. 1 shows a schematic view of an example of a situation in a building with a plurality of floors and of an example of an elevator system;

FIG. 2 shows an exemplary representation of a first exemplary embodiment of a method for operating the elevator installation;

FIG. 3 shows an exemplary representation of a second exemplary embodiment of a method for operating the elevator system;

FIG. 4 shows a schematic representation of controlled car doors and shaft doors; and

FIG. 5a-5b show schematic representations of exemplary slat systems.

### DETAILED DESCRIPTION

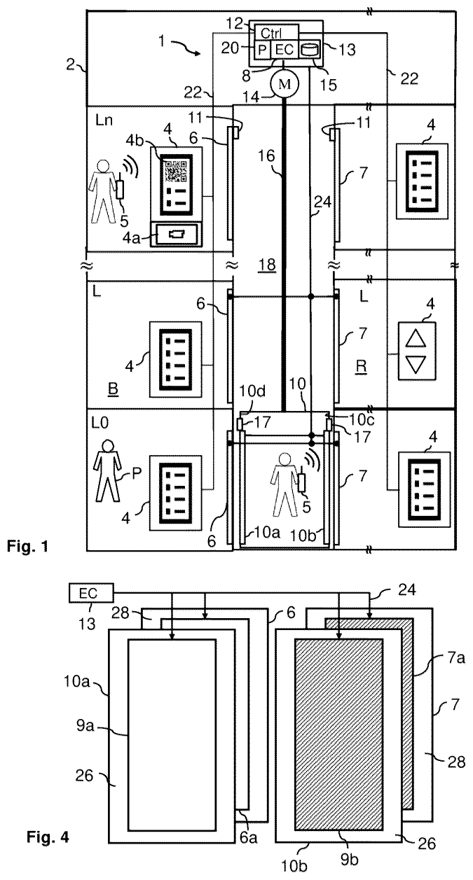

FIG. 1 is a schematic representation of an exemplary situation in a building 2, which has a plurality of floors L0, L, Ln and an elevator system 1 with at least one elevator car 10, which serves the floors L0, L, Ln along an elevator shaft 18. An elevator controller 13, inter alia equipped with a memory device 15 can move the elevator car 10 according to elevator calls entered on elevator operating devices 4. In the exemplary embodiments described herein, the building 2 can be a building with mixed use in which, for example, there are apartments and commercially used space. The building 2 may have originally been planned for mixed use, but the mixed use may also have arisen over time following a corresponding adaptation or conversion of the building 2. The elevator system 1 can therefore be used by several user groups: For example, residents can be assigned to a resident user group, and commercial users can be assigned to a commercial user group.

The elevator system 1 serves the floors L0, L, Ln by transporting a passenger (or the elevator car 10) from a call input floor to a destination floor. In one exemplary embodiment, operation can begin when the elevator call is received, and can end when the passenger leaves the elevator car 10 on the destination floor. Depending on the elevator system and its current situation (e.g., number and position of elevator cars 10), the received elevator call can be processed, e.g., to select a car 10 for the journey and to plan the journey (e.g., possible movement to the call input floor and subsequent movement to the destination floor with or without an intermediate stop).

In the exemplary building situation shown in FIG. 1, the disclosure described herein can be used in an advantageous manner. Briefly and by way of example, the disclosure described herein can enable a call input floor and/or a destination floor to be ascertained based on a received elevator call from a passenger. From this, an operating mode can be ascertained according to which the elevator car 10 is to be controlled. This can determine where the passenger is when the call is entered and/or where the passenger wants to go. Determining the call input floor and/or the destination floor can also determine the user group to which the passenger is assigned. The elevator call can then be operated according to the ascertained operating mode; the operation of the elevator call can therefore be specific to user groups. For example, elevator calls that are entered by residents on residential floors can be operated more slowly than elevator calls that are entered on commercial floors. As explained herein, longer service times can be defined for residents to service the elevator call. The occupant may already have to wait longer on the boarding floor to board the car 10; in order to service the elevator call of the resident, the car 10 can be moved to a boarding floor at a slower speed, a car door can be opened more slowly and/or a call assignment algorithm can apply at least one call assignment criterion so that, for example, a journey can be made with several intermediate stops or with the lowest possible energy consumption. In contrast, service times can be optimized for commercial users, e.g., to keep waiting times on the boarding floor or the travel time as short as possible.

An operating mode can have at least one operating parameter which in one exemplary embodiment is saved in the memory device 15. The at least one operating parameter can define a priority level, a call assignment criterion or a speed variable. The speed variable can define a car travel speed, a car acceleration, a car deceleration, an opening and closing speed of a car door or a hold-open time of the car door. A first operating mode may differ from a second operating mode in terms of at least one operating parameter. A person skilled in the art will recognize that an operating mode can comprise a plurality of these operating parameters.

In one exemplary embodiment, the service time, in particular the different service times for the different user groups, can be influenced by an operating parameter of an operating mode defining a priority level according to which an elevator call is to be serviced. Depending on the design of the elevator system 1, all or some of the operating modes can have an operating parameter that defines an individual priority level. If no priority level is defined, the elevator controller 1 can evaluate this as “no priority” or “lowest priority level”. In building 2, for example, there can be a plurality of elevator calls from different user groups at basically the same time, e.g., a first elevator call from a first passenger (resident) and a second elevator call from a second passenger (commercial user). In such a case, the elevator controller 13 can ascertain a priority level that is assigned to the user group to which the first passenger belongs. For the second (or additional) elevator call, the elevator controller 13 can ascertain (also based on an ascertained second call input floor and/or an ascertained second destination floor) the user group to which the second passenger belongs and the priority level of the second user group. The elevator controller 13 can control the elevator car 10 in such a way that the elevator call is prioritized which originates from the user group that has priority over the other user group according to its priority level.

Reference is again made to the situation shown in FIG. 1, wherein the upper floors (Ln), for example, can be exclusively residential floors, each having at least one apartment, and the lower floors (L0) can be exclusively commercially used floors (hereinafter also referred to as commercial floors). In addition to these exclusive uses, a part of the building on one floor can be used for at least one apartment (“residential part of the building”) and another part of the building can be used for commercial purposes (“commercial part of the building”). For example, a business can use one or more floors L0, L. If there is a plurality of floors, these can be consecutive in the vertical direction, e.g., the business uses the neighboring floors L0 and L, but one or more floors can also be non-consecutive, e.g., there is at least one floor not used by the business between two floors used by the business. In the latter case, a floor not used by this business can be used by another business or for one or more apartments; on this unused floor, one part of the building can be used for residential purposes and another part of the building for commercial purposes. A person skilled in the art will recognize that, like the commercial floors, the residential floors may not be consecutive.

A person skilled in the art will also recognize that the disclosure described herein is not limited to mixed use by apartments and businesses, but also includes sole use by commercial users (e.g., various businesses). For example, one or more floors or parts of a building can be used by a hotel company, while other floors or parts of a building on these floors can be used by other businesses (e.g., stores, law firms, etc.). The following description refers to mixed use by apartments and businesses by way of example.

The elevator system 1 installed in the building 2 can be configured to serve the floors L0, L, Ln in accordance with the usage scenarios described herein. Residents of the apartments can use elevator system 1 to be transported from one residential floor (residential part of the building) to another residential floor (residential part of the building) or to a building access floor (entrance hall), or to be transported from the entrance hall to a residential floor (residential part of the building). Accordingly, persons (e.g., employees, hotel guests, visitors, etc.) who use the floors for commercial purposes can be transported between the individual commercial floors and between the commercial floors and the entrance hall. Depending on the building 2, both user groups (residents and commercial persons) can use the same entrance hall, but separate entrances to the elevator system 1 can also be provided. The building 2 can also have separate entrance halls (e.g., on different floors). A person skilled in the art will recognize that the elevator system 1, possibly in conjunction with an access control system, can be configured to detect and verify credentials before a resident or other person can be transported to a floor.

In the exemplary situation shown in FIG. 1, a part of the building B to the left of the elevator shaft 18 on the floor L, for example, can be used for commercial purposes. Persons therefore can use the elevator system 1 from this left-hand commercial part of the building B, e.g., while a person is in the commercially used commercial part of the building B, they input an elevator call there, for example, and then board the elevator car 10 that serves the elevator call from there. In FIG. 1, a residential part of the building R to the right of the elevator shaft 18 can be used for residential purposes. The residents therefore can use the elevator system 1 from this (right-hand) residential part of the building R. The parts of the building B and R can be separated from one another by structural measures (e.g., walls). A person skilled in the art will recognize that other floors L0, Ln can also be divided into parts of the building. As explained herein, the elevator system 1 can recognize on which floor L0, L, Ln and in which part of the building B, R an elevator call is input and which destination (floor L0, L, Ln, and/or part of the building B, R) a passenger has.

The use of the building 2, for example, its division into floors L0, L, Ln, the arrangement of any parts of the building B, R and the accesses to the building 2 and the elevator system 1 can be defined in a building plan in one exemplary embodiment. The building plan can be stored in electronic form in the elevator system 1 or in a building management system. The elevator system 1 can use this saved building plan, for example, when planning an elevator ride. If, for example, the use and/or layout of the floors L0, L, Ln or parts of the building B, R changes in the building 2, the building plan can be updated at a central location.

For the purposes of illustration, FIG. 1 shows only the elevator controller 13, a drive machine 14, a suspension means 16 (e.g., steel cables or flat belts), and an elevator car 10 (also referred to as car 10), which is suspended on the suspension means 16 and is movable in the elevator shaft 18 under the control of the elevator controller 13, and a number of elevator operating devices 4 of the elevator system 1. In one exemplary embodiment, a mobile apparatus 5 can be used for call input. The mobile apparatus 5 can be, for example, a (card-like) credential with, for example, RFID radio technology or an optical code (e.g., barcode or QR code) or a cell phone with a corresponding software application, possibly in conjunction with Bluetooth technology, a code scanner or a display unit for an optical code. These options for call input are shown schematically in FIG. 1 by a cell phone apparatus 5, a code scanner 4a and a display unit 4b for a QR code. Depending on the option or options used in the building 2, the elevator system 1 can be accordingly designed on the floor and/or in the car; such designs are known to a person skilled in the art. In the exemplary embodiments described herein, a call can be entered on one of the elevator operating devices 4, but is not limited thereto.

The elevator controller 13 can comprise a plurality of functions, which are shown in FIG. 1 by a control and processing device 12 (Ctrl), a drive control 8 (EC) and a position determining device 20 (P). The control and processing device 12, the drive control 8 and the position determining device 20 can, for example, be combined in one unit (elevator controller 13) and arranged at a central location in the elevator shaft 18 (e.g., in the shaft head); they can also be arranged separately and/or distributed. Functions of the elevator controller 13 can also be carried out in whole or in part by the elevator operating devices 4 and/or by components of the elevator car 10 or components arranged thereon. A person skilled in the art will recognize that the elevator system 1 can also comprise a plurality of cars 10 in one or more shafts 18; a plurality of cars 10 can form an elevator group that is controlled by a group controller. The elevator system 1 can also comprise a plurality of elevator groups. If a plurality of cars 10 are available, one can be ascertained as part of a call assignment process to serve an entered elevator call. Instead of a traction elevator (shown in FIG. 1), the elevator system 1 can also have one or more hydraulic elevators.

The elevator car 10 shown in FIG. 1 by way of example has a car door 10a on a car wall 10d and a car door 10b on a car wall 10c. FIG. 1 also shows a number of shaft doors 6, 7 which separate the elevator shaft 18 from the floors L0, L, Ln. In one exemplary embodiment, a shaft door 6, 7 can be opened and closed by being coupled to one of the car doors 10a, 10b if the elevator car 10 is located on the floor L0, L, Ln and can thereby be moved by the car door 10a, 10b. In the shown exemplary embodiment, the car doors 10a, 10b and the shaft doors 6, 7 are connected to the elevator controller 13 via a communication network 24.

A communication network 22 connects the elevator operating devices 4 to the elevator controller 13 and thus makes communication possible between the elevator controller 13 and the elevator operating devices 4. For this communication, the elevator operating devices 4 and the elevator controller 13 may be directly or indirectly connected to the communication network 22.

The communication networks 22, 24 can each comprise a communication bus system, individual point-to-point lines, or a combination thereof. Depending on the implementation of the communication networks 22, 24, the elevator controller 13, each elevator operating device 4, each car door 10a, 10b and each shaft door 6, 7 can be assigned individual addresses and/or identifiers, so that, for example, the elevator controller 13 can address and send a message specifically to a particular elevator operating device 4 or a control signal to a particular car door 10a, 10b. Communication can take place in accordance with a protocol for wired communication, for example, the Ethernet protocol. With the above-mentioned addressing or the point-to-point line connection, the elevator controller 13 (e.g., in conjunction with the above-mentioned building plan) can recognize, among other things, on which floor L0, L, Ln, in which part of the building (B, R) and at which elevator operating device 4 a resident or other person inputs an elevator call. The recognized floor L0, L, Ln or the recognized part of the building (B, R) can specify a boarding location (boarding floor and boarding side into the car 10) for a desired ride to a destination floor.

The elevator installation 1 can be equipped with an up/down controller (also direction controller) or a destination call controller, for example. A person skilled in the art recognizes that mixed forms of the aforementioned control technologies can also be possible. If the elevator system 1 is equipped with an up/down controller, elevator operating devices 4 can be arranged on the floors L, L0, Ln on each of which an elevator call (also floor call or direction call) can be input for a desired direction of travel. For illustration purposes, such an elevator operating device 4 is shown in FIG. 1 on the floor L in the part of the building R. The boarding floor or the part of the building B, R on this boarding floor can determined by the location of the elevator operating device 4, which is documented in the building plan, for example. The desired destination floor may then be input in the car 10 on an elevator operating device arranged there (not shown in FIG. 1); such a call input is also referred to as a car call. A communication line may connect the (car-side) elevator operating device to the elevator controller 13. The drive controller 8 can control the travel of the elevator car 10 according to the destination floor input in the car 10.

If the elevator system 1 is equipped with a destination call controller, elevator operating devices 4 can be arranged on the floors L, L0, Ln on which a passenger P can input a desired destination floor; a destination call can then be registered as an elevator call. For illustration purposes, such elevator operating devices 4 are shown in FIG. 1 on floors L0, Ln and on floor L in the part of the building B. Once the passenger has entered the destination floor, information about the entry floor and the destination floor can be available. The boarding floor or the part of the building B, R on this boarding floor is determined by the location of the elevator operating device 4 (e.g., from the building plan) at which the destination floor is entered. The control and processing device 12 shown in FIG. 1 serves as a destination call controller that assigns an elevator car 10 to the entered destination call. The drive controller 8 can control the movement of the elevator car 10 according to the destination call.

To transport a passenger, the elevator system 1 can be controlled according to defined operating parameters. For example, the elevator controller 13 can assign the elevator call to the elevator car 10 (or one of several cars 10) and move the (assigned) elevator car 10 according to the boarding floor and the destination floor. The operating parameters can include, for example, a car travel speed, a car acceleration, a car deceleration (negative acceleration), an opening and closing speed of a car door, a hold-open time of the car door and/or a call assignment criterion (e.g., with regard to minimized waiting time or travel with or without an intermediate stop).

According to the disclosure described herein, different service times can be defined for the various user groups. Accordingly, a plurality of operating modes can be defined and saved in the elevator system 1 or in the elevator controller 13. Each operating mode can define at least one operating parameter that is specific to a user group. For example, an operating mode that is assigned to the “resident” user group may differ by at least one operating parameter from an operating mode that is assigned to the “commercial user” user group. For example, a resident may have to wait longer for a car 10 than a commercial user because the call assignment is slower (e.g., because other elevator calls are served with priority) and/or the elevator car 10 is moved to the boarding floor more slowly.

The service time, or the total time a passenger associates with an elevator use, can indicate the amount of time it takes to service an elevator call. The service time can comprise three time intervals. A first time interval can be the time that a passenger waits on the call input floor for the arrival of the elevator car 10; this time is also referred to as “waiting time.” A second time interval can be the “door dwell time” or the amount of time the elevator doors are open so that passengers can enter or exit the elevator car 10. A third time interval can be the “travel time” or the time a passenger spends in the elevator car 10. The travel time can also include a stop on an intermediate floor. In one exemplary embodiment, the service time can begin at the time of the call input on an elevator operating device 4 and ends at the time when the passenger steps out of the car 10 on the destination floor. A person skilled in the art recognizes that the service time can also define a different time period.

The elevator controller 13, in particular the drive controller 8, can control, for example, the movement according to the mentioned operating parameters as a function of a (current) position of the elevator car 10 in the elevator shaft 18 and the next stopping floor. Braking of the elevator car 10 can be initiated, for example, if the car 10 is located within a floor zone defined for the stopping floor. In the elevator system 1, a corresponding functionality can be provided for position determination; in FIG. 1, this functionality is implemented with the position determining device 20, which is assigned to the elevator controller 13, for example, for the purposes of illustration.

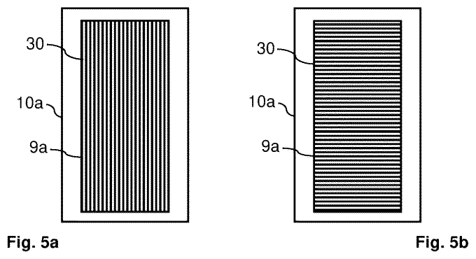

Further details on the design of the elevator system 1, in particular on the structures and functionalities of the car doors 10a, 10b and the shaft doors 6, 7 and their communication with the elevator controller 13 are described herein, including in connection with FIG. 4, FIG. 5a and FIG. 5b.

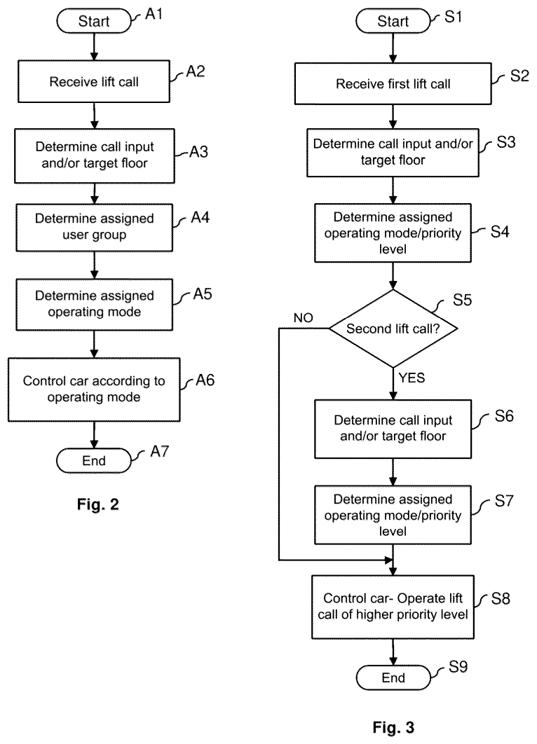

With an understanding of the elevator system 1 described herein and its functionalities, exemplary embodiments of exemplary uses are described herein. FIG. 2 provides a description of a first exemplary method for operating the elevator system 1, and FIG. 3 provides a description of an additional exemplary method for operating the elevator system 1. The elevator system 1 and the use of the building 2 can be configured as shown by way of example in FIG. 1. As mentioned above, the call can be entered on one of the elevator operating devices 4. In FIG. 2 and FIG. 3, the method is shown in each case with an exemplary flowchart with a number of steps. A person skilled in the art will recognize that the division into these steps is by way of example, and that one or more of these steps may be divided into one or more sub-steps, or that several of the steps may be combined into one step. Some steps can also be performed in a different order than shown, and some steps can be performed substantially simultaneously.

The method according to FIG. 2 begins with a step A1 and ends with a step A7. In a step A2, an elevator call is received from the elevator controller 13. The elevator call is entered by a passenger, e.g., by a resident on one of the residential floors (or assigned entrance hall) or by a person on one of the commercial floors (or assigned entrance hall) in order to travel from there to a destination floor.

In a step A3, the elevator call is analyzed by the elevator controller 13 to determine a call input floor and/or a destination floor based on the elevator call. If the elevator call is a destination call, the call input floor and the destination floor can be ascertained. The call input floor can be ascertained in a floor call, and the destination floor in a car call.

In one exemplary embodiment, the elevator controller 13 can ascertain the elevator operating device 4 from which the elevator call is received. The elevator controller 13 can recognize (e.g., in conjunction with the building plan and the aforementioned addressing via the communication network 22) on which floor (call input floor) and on which elevator operating device 4 the resident enters the elevator call. The elevator controller 13 can therefore also ascertain whether the elevator car 10 should be moved to the call input floor. If the elevator car 10 is already on the call input floor, for example, it may not be necessary to move the elevator car 10 in this way. Since the elevator controller 13 can also recognize the elevator operating device 4 operated by the passenger, e.g., it can recognize on which side of the boarding floor the passenger is waiting (e.g., in building section R), this also can determine the cabin door 10a, 10b, which is to be opened towards this side.

Based on the first call input floor and/or the first destination floor ascertained in step A3, an operating mode can be ascertained by the elevator controller 13. The elevator controller 13 can read the corresponding data from the memory device 15 to determine the operating mode. In FIG. 2, this ascertainment of the operating mode is in two separate steps A4 and A5. In step A4, the elevator controller 13 ascertains a user group to which the passenger is assigned based on the call input floor and/or the destination floor ascertained in step A3. In one exemplary embodiment, the elevator controller 13 can also use the building plan for this purpose.

In step A5, the elevator controller 13 determines an operating mode from the saved operating modes, which is assigned to the user group ascertained in step A4. The elevator controller 13 reads the corresponding data from the memory device 15 to determine the operating mode.

The memory device can be an internal data memory of the elevator controller 13 or an external memory device which is communicatively connected to the elevator controller 13. The memory device 15 can save a specific operating mode, including the operating parameters, for each of the user groups defined in building 2, e.g., an operating mode for the “occupant” user group and an operating mode for the “commercial person” user group. A person skilled in the art recognizes that additional user groups and their floors or building sections can be defined in the building and documented in the building plan; the “residents” and “commercial person” user groups can be divided into subgroups, for example, for VIP residents or individual commercial companies.

In a step A6, the elevator car 10 is controlled by the elevator controller 13 according to the operating mode ascertained in step A5. As explained herein, elevator calls that are entered by residents on residential floors can be operated more slowly than elevator calls that are entered on commercial floors. The method ends at step A7.

In one exemplary embodiment of the method described in connection with FIG. 2, at least one of the operating modes may be subject to time restrictions during which it is applicable or not applicable. The memory device 15 also saves information on a validity period for each operating mode (or user group). For example, the operating mode for the “commercial person” user group can be used during normal workdays and business hours but not on weekends, other non-workdays (e.g., national holidays) or outside of business hours. Accordingly, the operating mode for the “residents” user group can be applicable on a workday during business hours so that, for example, residents are exposed to longer service times (e.g., longer waiting times) at that time.

According to this embodiment, the elevator controller 13 can check whether a received elevator call falls within a validity period of the operating mode ascertained in step A5. If the elevator call falls within the validity period (e.g., the elevator call from a resident is on a workday during business hours), the elevator controller 13 can control the elevator car 10 according to the ascertained operating mode. If this is not the case (e.g., a resident calls the elevator on a weekend or outside of business hours), the elevator controller 13 can control the elevator car 10 according to a standard mode. In standard mode, for example, an operating parameter that contributes to the longer service time can be reset to a default setting or deactivated. In one exemplary embodiment, the operating mode used for a user group can therefore also depend on saved time periods, e.g., commercial users have priority in the morning and residents in the evening.

In an additional embodiment of the method described in connection with FIG. 2, the applicability of at least one of the operating modes can depend on the current traffic volume in the elevator system 1. The elevator controller 13 can be designed to record and evaluate the load, the position and the operating status of an elevator car 10, the operating status of the drive machine 14 and additional information about the current and previous traffic volume for the elevator car 10 or for each elevator of the elevator system 1 at any time. The elevator controller 13 can be designed (e.g., with an executable computer program) to evaluate the number of entered elevator calls as a function of the time and the floor L0, L, Ln or also the floor terminals 4. An instantaneous traffic volume can also thereby be ascertained for each floor L0, L, Ln, for example.

According to this further embodiment, the memory device 15 can save a traffic threshold and a speed variable as defined operating parameters for an operating mode. The elevator controller 13 can determine a current traffic volume in the elevator system 1 and compare it with the traffic threshold of the ascertained operating mode which results from the ascertained first call input floor and/or the first destination floor. An initial speed variable can be defined for the ascertained operating mode. Falling below the traffic threshold of the ascertained operating mode may indicate a low traffic volume. It can then be ascertained whether slower operation of the elevator car 10 is defined for the ascertained operating mode (e.g., with regard to an elevator call by an occupant) compared to another operating mode defined in the elevator system 1 (e.g., with regard to an elevator call by a commercial person). Slower operation can result from a reduced car speed or car acceleration or a longer door open time. If operation is slowed down, an alternative operating mode can be selected for which a second speed variable is defined, whereby operation of the elevator car 10 can be accelerated compared to the first speed variable. In the alternative operating mode, for example, the driving speed can be increased. The elevator car 10 can then be controlled according to the alternative operating mode. If, for example, there is a low volume of traffic during business hours, the elevator call of a resident can also be serviced without the restrictions defined in the assigned operating mode; in particular the elevator call can be operated faster than in the assigned operating mode, for example. If, on the other hand, there is no slowed-down operation (e.g., due to an elevator call from a commercial person), the elevator car 10 can be controlled according to the ascertained operating mode.

According to an additional embodiment, the memory device 15 can save a service time threshold and a call assignment criterion as operating parameters for an operating mode. The elevator controller 13 can ascertain a current service time for servicing an elevator call in the elevator system 1. This can be an average value ascertained over a specified period. The elevator controller 13 can compare the current service time with the service time threshold of the ascertained operating mode which results from the ascertained first call input floor and/or the first destination floor. An initial call assignment criterion can be defined for the ascertained operating mode. Exceeding the service time threshold of the ascertained operating mode may indicate an increased service time, in particular an increased waiting time. This can mean that the duration from time of the call input to exiting the car 10 on the destination floor is longer than average. The elevator controller can ascertain whether a longer service time for servicing an elevator call is defined for the ascertained operating mode (e.g., with regard to an elevator call from an occupant) compared to another operating mode defined in the elevator system 1 (e.g., with regard to an elevator call from a commercial person). If this is the case, an alternative operating mode can be selected for which a second call assignment criterion is defined, which reduces the service time for servicing an elevator call compared to the first service time. In the alternative operating mode, for example, the second call assignment criterion can specify a minimized waiting time or a journey without an intermediate stop. The elevator car 10 can then be controlled according to the alternative operating mode. If this is not the case, the elevator car 10 can be controlled according to the ascertained operating mode.

The method shown by way of example in FIG. 3 for operating the elevator system 1 begins with a step S1 and ends with a step S9. Steps S2-S4 essentially correspond to steps A2-A4 shown in FIG. 2, wherein the at least one operating parameter defines a priority level for an operating mode, which is also ascertained in step S4. The priority level indicates the rank that an operating mode or the assigned user group has within a plurality of operating modes or user groups. In one exemplary embodiment, for example, the “commercial person” user group can have a higher rank than the “resident” user group and therefore can have priority over the “resident” user group.

Step S5 checks whether there is a second (further) elevator call to be serviced in addition to the first elevator call (step S2). This can occur, for example, if a resident and a (commercial) person in building 2 enter an elevator call at basically the same time.

If there is a second elevator call, the procedure proceeds along the yes branch to step S6. If, however, there is no second elevator call, the procedure proceeds along the no branch to a step S8, in which the elevator car 10 is controlled according to the operating mode ascertained for the first elevator call.

In step S6, the second elevator call is analyzed by the elevator controller 13 in order to ascertain a (second) call input floor and/or a (second) destination floor from the second elevator call. The ascertainment is analogous to step A3 in FIG. 2.

In a step S7, a (second) operating mode is ascertained based on the second call input floor and/or the second destination floor. The priority level is also ascertained for this. To ascertain the operating modes and the priority levels in steps S4 and S7, the elevator controller 13 reads the corresponding data from the memory device 15.

If there are two elevator calls, in step S8 the elevator controller 13 ascertains the operating mode that has priority over the other operating mode according to the priority level ascertained for it. The elevator controller 13 controls the elevator car 10 according to the ascertained priority operating mode, wherein the elevator call on which this operating mode is based is serviced with priority. The method ends at step S9.

Further details of the structures and functionalities of the car doors 10a, 10b and the shaft doors 6, 7 and their communication with the elevator controller 13 are described herein. The disclosure described herein, according to one or more of the aforementioned embodiments, can be used in particular in conjunction with these car doors 10a, 10b and shaft doors 6, 7 in the mixed-use building 2.

In the exemplary embodiment shown in FIG. 1, the car walls 10c, 10d and therefore the car doors 10a, 10b are arranged opposite one another; in an additional exemplary embodiment, the car walls 10c, 10d can be arranged adjacent to one another (e.g., at right angles). Regardless of their arrangement, the car doors 10a, 10b (or their electrical components, as indicated elsewhere in this description) can be connected to the elevator controller 13 via a communication network 24.

A person skilled in the art will recognize that the car door 10a, 10b can be configured in different ways. In one embodiment, it can comprise a sliding door whose door leaves, driven by an electric motor, can be moved sideways. In another design, the car door 10a, 10b can be configured as a hinged door or pivoting door; in this design, one or two door leaves can each be pivoted on the car wall. A person skilled in the art therefore understands the term “car door” to mean a door system with one or more door leaves that open and close access to the car 10, irrespective of a specific design.

The shaft doors 6, 7 shown in FIG. 1 can be designed according to one of the designs mentioned with regard to the car doors 10a, 10b. In the embodiment shown, two shaft doors 6, 7 are arranged on each floor L0, L, Ln; a person skilled in the art will recognize that only one shaft door 6, 7 can be arranged on one or more floors L0, L, Ln. In addition, the person skilled in the art will recognize that the elevator shaft 18 or its walls are generally part of the building 2 and walls of the elevator shaft 18 can also be building walls. The shaft doors 6, 7 can therefore be understood (as is also the case in this description) as being arranged on the building walls. A person skilled in the art will recognize that the arrangement of the shaft doors 6, 7 can also be understood as being arranged on the shaft walls. The arrangement of the shaft doors 6, 7 (e.g., opposite one another) can correspond to the arrangement of the car doors 10a, 10b.

In one exemplary embodiment, the shaft doors 6, 7 (or their electrical components) can be communicatively coupled to the elevator controller 13 via the communication network 24; in FIG. 1, this coupling is shown schematically on floors L0, L. In an additional exemplary embodiment, each shaft door 6, 7 can have an electrical contact element 11 which faces the elevator shaft 18 and which comes into electrical contact with a complementary contact element 17 on the car 10 if the car 10 stops at a floor. The contact elements 11 on the floor Ln are shown schematically in FIG. 1. Such contact elements are known to a person skilled in the art. An electrical control signal can be transmitted to a shaft door 6, 7 (or an electrical component of the shaft door 6, 7) by coupling via the communication network 24 or contacting via the contact elements 11, 17. In one exemplary embodiment of the elevator system 1, either the above-mentioned coupling can be via the communication network 24 or via the contacting by the contact elements 11, 17.

In one exemplary embodiment, the car doors 10a, 10b each optionally comprise a door element 9a, 9b, which can assume the at least two states of visual permeability and which controls the elevator controller 13 with an electrical control signal. The term “visual permeability” describes how the view through the door element 9a, 9b is impaired to a greater or lesser extent. With a transparent door element, the view may not substantially be impaired, because it is translucent or transparent. With an opaque door element, the view can be so severely impaired that it allows no or very little light through, making it virtually non-transparent. In addition to these extremes of transparent and opaque, a material can also be translucent, e.g., partially transparent. Depending on the application, it may be sufficient not to completely obstruct the view, but merely to more or less break it up; for example, it may be acceptable or desirable for a person behind a pane of glass to be dimly perceptible (visible) without it being possible to recognize who they are. As explained herein, the visual permeability states can be implemented in various ways.

According to one exemplary embodiment, the door element 9a, 9b can comprise a glass panel which has fixed dimensions ((vertical) length, width, thickness) for the car door 10a, 10b. According to one exemplary embodiment, these dimensions, in particular length and width, can substantially correspond to a dimension of the relevant car door 10a, 10b, e.g., the car door 10a, 10b is substantially a glass door. Depending on the configuration, a metal frame structure, for example, can completely or partially surround the glass panel. In an additional exemplary embodiment, the dimensions of the door element 9a, 9b can be smaller than the dimensions of the respective car door 10a, 10b; e.g., the door element 9a, 9b is located in a part of the car door 10a, 10b, for example, the door element 9a, 9b can completely or partially occupy an upper half of the car door 10a, 10b. A person skilled in the art will recognize that a different division is also possible and that a car door 10a, 10b can comprise a plurality of door elements 9a, 9b.

In a further exemplary embodiment, a door element 9a, 9b can comprise an electromechanically adjustable slat system 30. The slat system 30 has an adjusting mechanism and a plurality of slats (e.g., strip-shaped elements made of metal, plastics, fabric or a combination thereof), which can be rotatably mounted about their longitudinal axis, in order to be able to set a desired angle of rotation; the slats can also be displaceable relative to one another, so that they overlap to a greater or lesser extent. Such slat systems 30 are known to a person skilled in the art, for example, in the field of blinds for windows. FIG. 5a shows the slat system 30 with a vertical arrangement of the slats, and FIG. 5b shows the slat system 30 with a horizontal arrangement of the slats. A person skilled in the art will recognize that the slats can also be arranged in a different way and that the slats can be arranged between two panes of glass for protection, for example.

In one exemplary embodiment, the shaft doors 6, 7 are optionally configured in the same way as the car doors 10a, 10b. For example, on a floor L0, L, Ln with two shaft doors 6, 7, the shaft door 6 can be arranged on a first building wall and can comprise an electrically controllable door element 6a. The shaft door 7 can be arranged on a second building wall and can comprise an electrically controllable door element 7a. On the floor L, the shaft door 6 can open in the direction of the part of the building B and the shaft door 7 can open in the direction of the part of the building R. The door elements 6a, 7a likewise can have at least two visual permeability states and are communicatively coupled to the elevator controller 13 in one of the ways described herein, in order to control the door element 6a, 7a of a shaft door 6, 7 to be opened in accordance with the first visual permeability state.

FIG. 4 shows an exemplary embodiment of the car doors 10a, 10b and the shaft doors 6, 7, wherein the shaft doors 6, 7 are partially concealed by car doors 10a, 10b arranged in the foreground. For illustration purposes, the elevator controller 8 is shown, which is connected to the door elements 9a, 9b of the car doors 10a, 10b and the shaft door elements 6a, 7a of the shaft doors 6, 7. Each of the car doors 10a, 10b has a frame structure 26, which partially or substantially completely surrounds the door element 9a, 9b laterally (as shown in FIG. 4). In this exemplary embodiment, the door element 9a, 9b occupies almost the entire vertical surface of the car door 10a, 10b. Accordingly, each of the shaft doors 6, 7 shown in FIG. 4 has a frame structure 28, which partially or substantially completely surrounds the shaft door element 6a, 7a laterally (as shown in FIG. 4).

In the exemplary embodiment described here, each door element 6a, 7a, 9a, 9b comprises a special glass, the visual permeability of which can be changed as a whole by being controlled by an electrical control signal, the control being effected in particular by an applied electrical voltage. A suitable voltage (e.g., in terms of voltage value and frequency) can be provided by the elevator controller 13 or by a voltage source arranged on or near the doors 6, 7, 10a, 10b. In the latter case, the elevator controller 13 can control the voltage sources. Depending on the electrical voltage applied, the glass is transparent or opaque or non-transparent. The properties “transparent” and “opaque” refer to the range of the electromagnetic spectrum that is visible to humans. In FIG. 4, for illustration, the door element 9a of the car door 10a is shown in a transparent state (e.g., it is translucent) and the door element 9b of the car door 10b is shown in an opaque state; the opaque state is shown in FIG. 4 by hatching. Correspondingly, the shaft door elements 6a, 7a of the shaft doors 6, 7 are shown in FIG. 4.

This type of glass is also known as smart, dynamic or switchable glass. This can be an electrochromic glass or a liquid crystal glass, for example, wherein the light transmission of these glasses can be changed by applying an electrical voltage. Without voltage applied, the liquid crystal glass can be opaque, for example. For example, US 2021/302770 A1 describes a modular wall system comprising a frame and a smart glass pane. An electrical connecting element is attached to a cross strut of the frame, which is connected to an electrical connecting element on the smart glass pane. The wall system also comprises a power connection to receive a direct current (DC) input voltage from a power source. An inverter converts the DC input voltage into an alternating voltage (AC), which is applied to the smart glass pane.

The design of the car doors 10a, 10b and the shaft doors 6, 7 with the aforementioned door elements 6a, 7a, 9a, 9b is optional, as mentioned herein. An elevator system 1 can be designed with or without such door elements 6a, 7a, 9a, 9b, including their corresponding control. A person skilled in the art recognizes that the door elements 6a, 7a, 9a, 9b in a mixed-use building 2 can help separate the different uses or user groups.

The position determining device 20 shown in FIG. 1 can be designed in accordance with known devices for determining the position of the elevator car 10; these include, for example, magnetic tape-based measuring systems and laser-based optical measuring systems. With magnetic tape technology, a sensor mounted on the elevator car detects the current absolute car position using Hall sensors, which contactlessly scan a magnetic tape mounted in the shaft. A laser-based optical measuring system is known, for example, from DE 10126585 A1. This document uses a system with a laser and a detector in order to determine a distance from a measured light travel time and from this a position of an elevator car. A person skilled in the art will recognize that the position determining device 20 and/or components of the position determining device 20 can be arranged outside the elevator controller 13 and/or distributed in the elevator system 1. The representation of the position determining device 20 in the elevator controller 13 is therefore to be understood as exemplary.

In one exemplary embodiment, the elevator operating devices 4 can be supplied with electrical power via the communication network 22; this is also known as “Power over Ethernet” (PoE). If an elevator operating device is arranged in the car 10 (e.g., if, according to a control technology of the elevator system 1, a desired destination floor is to be input in the car 10), a corresponding communication line can be provided in one exemplary embodiment for communication and for supplying power to the elevator operating device. FIG. 1 shows no such communication line and no elevator operating device for call input in the car 10; however, the person skilled in the art will recognize that the car 10 has an elevator operating device which comprises, for example, buttons for an emergency call and door commands (open/close) and, depending on the control technology, can comprise buttons for inputting a desired destination floor.

In the situation shown in FIG. 1 and according to an exemplary embodiment of the elevator system 1 and its mode of operation described herein, the elevator system 1 can be used by residents and other persons, e.g., in the case of a building with mixed use, without them meeting or becoming aware of one another when using the elevator system 1. In one exemplary embodiment, e.g., as shown in FIG. 4, it is possible to steer or guide residents and people. If, for example, a resident uses the elevator system 1 for a ride between a residential floor and the (residents’) entrance hall, the door element 9a, 9b of the car door 10a, 10b can become transparent, e.g., during the ride to the next stop, which will open. The other car door 10a, 10b, however, can remain opaque. The door elements 9a, 9b of the car doors 10a, 10b can be controlled in an analogous manner if a person is transported between a commercial floor and the (commercial) entrance hall. A transparent or a door element 9a, 9b that becomes transparent can notify a passenger (resident or other person) in the elevator car 10 which car door 10a, 10b will open at the next stop; the passenger can therefore be prepared for disembarking and guided towards the exit side.

According to one exemplary embodiment, passengers can be prevented from seeing or looking into parts of the building (B, R) that are unfamiliar to the passengers in the above-mentioned building with mixed use. The controller 11 can control the door elements 9a, 9b of the car doors 10a, 10b and the shaft door elements 6a, 7a of the shaft doors 6, 7 in such a way that, for example, a resident cannot see onto a commercial floor during the ride or when the car stops. This can also apply in an analogous manner to a person who uses a commercial floor. In one exemplary embodiment, the shaft door elements 6a, 7a of the shaft doors 6, 7 can be opaque, except if an elevator car 10 with a car door 10a, 10b to be opened is located behind it or shortly before the elevator car 10 arrives. The shaft door element 6a, 7a of a shaft door 6, 7 to be opened can be in a transparent state when the elevator car 10 stops. If the door elements 6a, 7a, 9a, 9b of the doors to be opened (6, 7, 10a, 10b) are transparent, boarding passengers can see whether passengers are disembarking, for example; this also applies in the opposite direction.

In addition, in the case of shaft doors 6, 7, which are arranged opposite the car doors 10a, 10b, the relevant door elements 6a, 7a, 9a, 9b can be controlled in such a way that at no time is it possible to see across the elevator shaft 18 to the other part of the building. When using the elevator system 1, a resident therefore may not see that the ride passes, begins or ends on a floor that is used wholly or partially for commercial purposes. The privacy of the various user groups can therefore be preserved.

The resident in the above example can input an elevator call on a residential floor or in an entrance hall, in order to travel from there to the entrance hall or to a residential floor. The elevator controller 13 can recognize (e.g., in conjunction with the building plan) on which floor (boarding floor) and on which elevator operating device 4 the resident inputs the elevator call, and can cause the elevator car 10 to move to the boarding floor. If the elevator car 10 is already on the boarding floor, such moving of the elevator car 10 is unnecessary. Since the elevator controller 13 can also recognize the elevator operating device 4 operated by the resident, e.g., it recognizes on which side of the boarding floor the resident is waiting (e.g., in the part of the building R), it can control the car door 10a, 10b to be opened to this side. The elevator controller 13 can control the door element 9a, 9b of this car door 10a, 10b in such a way that the door element 9a, 9b is transparent if the elevator car 10 arrives at the boarding floor and the car door 10a, 10b is opened, or if the car door 10a, 10b of the elevator car 10 already standing there is opened. The door element 9a, 9b of the other car door 10a, 10b, on the other hand, can be controlled so that it is opaque. If the elevator car 10 is then ready for boarding, e.g., the shaft door 6b and the car door 10a are open, the resident can enter the car 10 and can then be transported to the desired destination floor. Depending on the control technology, the destination floor can be transmitted to the elevator controller 13 in conjunction with a destination call or a car call.

Position determination can be used to adjust the visual permeability settings during a ride, e.g., to ensure privacy. In one exemplary embodiment, the use of a floor or part of a building defined in the building plan can be used to determine whether the ride passes at least one floor or part of a building that is defined as visible or not visible in the building plan. The door elements 9a, 9b of the car door 10a, 10b and/or the shaft door elements 6a, 7a can be controlled while the car is moving in the first or second visual permeability state, depending on the use defined in the building plan. Whether a floor or part of a building is visible or not can be determined by individual persons or by a building manager. For example, commercially used floors may never be visible during the ride; this may apply to a ride by a resident who passes a commercial floor, but also to other persons (commercial users). In one exemplary embodiment, the visibility or non-visibility can be defined specifically for the user groups; for example, the “residents” user group can see the residential floors from the elevator car, but not the commercial floors, and vice versa.

1-14. (canceled)

15. A method for operating an elevator system in a building comprising at least one first floor or at least one first floor area for a first user group and at least one second floor or at least one second floor area for a second user group wherein at least one operating mode is assigned to each the first user group, the second user group, the at least one first floor or at least one first floor area and the at least one second floor and at least one second floor area and is saved in a memory device, wherein the elevator system comprises an elevator controller and an elevator car movable in an elevator shaft, wherein the method comprises:
receiving a first elevator call by the elevator controller;
analyzing the first elevator call by the elevator controller to determine at least one of a first call input floor or a first destination floor based on the first elevator call;
determining, based on the at least one of the first call input floor or the first destination floor, an operating mode by the elevator controller, wherein the elevator controller reads corresponding data from the memory device for ascertaining the operating mode; and
controlling the elevator car by the elevator controller according to the ascertained operating mode.

16. The method of claim 15, wherein an operating mode comprises at least one operating parameter, wherein the at least one operating parameter comprises at least one of a priority level, a call assignment criterion or a speed variable, wherein the speed variable comprises at least one of a car traveling speed, a car acceleration, a car deceleration, an opening and closing speed of a car door or a hold-open time of the car door, wherein a first operating mode differs by at least one operating parameter from a second operating mode.

17. The method of claim 16, wherein the at least one operating parameter is configured to set a priority level for an operating mode, the method further comprising:
determining a first priority level which is defined by the at least one operating parameter of the ascertained first operating mode, wherein the elevator controller reads corresponding data from the memory device to ascertain the first priority level;
checking whether there is a second elevator call;
if there is a second elevator call, analyzing the second elevator call to determine at least one of a second call input floor or a second destination floor from the second elevator call;
based on at least one of the second call input floor or the second destination floor, ascertaining a second operating mode and a second priority level which is defined by the at least one operating parameter of the second operating mode, wherein the elevator controller reads corresponding data from the memory device for ascertaining the second operating mode and the second priority level;
ascertaining, from the first operating mode and the second operating mode, the operating mode which has priority over the other operating mode according to the priority level ascertained for it; and
controlling the elevator car according to the ascertained priority operating mode, wherein the elevator call on which this operating mode is based is serviced with priority.

18. The method of claim 16, wherein the at least one operating parameter further comprises at least one of a traffic threshold or a speed variable, the method further comprising:
determining a current traffic volume in the elevator system;
comparing the current traffic volume with the traffic threshold of the operating mode which was ascertained from at least one of the first call input floor or the first destination floor, wherein a first speed variable is defined for the operating mode;
ascertaining whether a slower operation of the elevator car is defined for the ascertained operating mode compared to another operating mode defined in the elevator system if the traffic threshold of the operating mode is undershot which indicates a low traffic volume;
selecting, if the traffic threshold of the operating mode is undershot, an alternative operating mode for which a second speed variable is defined, which accelerates an operation of the elevator car compared to the first speed variable;
controlling the elevator car according to the alternative operating mode if the traffic threshold of the operating mode is undershot, and
controlling the elevator car according to the ascertained operating mode if the traffic threshold of the operating mode is not undershot.

19. The method of claim 17, wherein the at least one operating parameter further comprises at least one of a traffic threshold or a speed variable, the method further comprising:
determining a current traffic volume in the elevator system;
comparing the current traffic volume with the traffic threshold of the operating mode which was ascertained from at least one of the first call input floor or the first destination floor, wherein a first speed variable is defined for the operating mode;
ascertaining whether a slower operation of the elevator car is defined for the ascertained operating mode compared to another operating mode defined in the elevator system if the traffic threshold of the operating mode is undershot which indicates a low traffic volume;
selecting, if the traffic threshold of the operating mode is undershot, an alternative operating mode for which a second speed variable is defined, which accelerates an operation of the elevator car compared to the first speed variable;
controlling the elevator car according to the alternative operating mode if the traffic threshold of the operating mode is undershot, and
controlling the elevator car according to the ascertained operating mode if the traffic threshold of the operating mode is not undershot.

20. The method of claim 16, wherein the at least one operating parameter further comprises at least one of a service time threshold or a call assignment criterion, the method further comprising:
determining a current service time for servicing an elevator call in the elevator system;
comparing the current service time with the service time threshold of the operating mode, which was ascertained from at least one of the first call input floor or the first destination floor, wherein a first call assignment criterion is defined for the operating mode;
ascertaining whether a longer service time for servicing an elevator call is defined for the operating mode compared to another operating mode defined in the elevator system if the service time threshold of the operating mode is exceeded, which indicates an increased service time, in particular an increased waiting time;
selecting, if the service time threshold of the operating mode is exceeded, an alternative operating mode for which a second call assignment criterion is set which reduces the service time for servicing an elevator call compared to the first service time, controlling the elevator car according to the alternative operating mode; and
controlling the elevator car according to the operating mode if the service time threshold of the operating mode is not exceeded.

21. The method of claim 15, wherein the memory device is configured to save at least one validity period for an operating mode, the method further comprising:
checking, with the elevator controller, whether a received elevator call falls within a validity period of the operating mode;
controlling the elevator car with the elevator controller according to the operating mode if the received elevator call falls within the validity period of the operating mode; and
controlling the elevator car with the elevator controller according to a standard mode if the received elevator call does not fall within the validity period of the operating mode.

22. The method of claim 16, wherein the memory device is configured to save at least one validity period for an operating mode, the method further comprising:
checking, with the elevator controller, whether a received elevator call falls within a validity period of the operating mode;
controlling the elevator car with the elevator controller according to the operating mode if the received elevator call falls within the validity period of the operating mode; and
controlling the elevator car with the elevator controller according to a standard mode if the received elevator call does not fall within the validity period of the operating mode.

23. The method of claim 21, wherein the validity period comprises at least one of:
at least one day of the week;
at least one time of the day; or
at least one period of the day.

24. The method of claim 15, further comprising ascertaining, based on at least one of the first call input floor or the first destination floor, a user group to which a passenger who initiates an elevator call is assigned.

25. The method of claim 16, further comprising ascertaining, based on at least one of the first call input floor or the first destination floor, a user group to which a passenger who initiates an elevator call is assigned.

26. The method of claim 15, wherein at least one of the operating modes defined in the elevator system is defined such that elevator calls are serviced differently by the elevator controller, at least temporarily, depending on the user group.

27. The method of claim 15, wherein the first elevator call is a destination call initiated outside the elevator car, and wherein the first call input floor and the first destination floor are ascertained by the elevator controller from the destination call.

28. The method of claim 15, wherein the first elevator call is a floor call initiated outside the elevator car and which indicates a desired direction of travel, wherein the first call input floor is ascertained by the elevator controller from the floor call.

29. The method of claim 15, wherein the first elevator call is a car call initiated in the elevator car, wherein the first destination floor is ascertained by the elevator controller from the car call.

30. An elevator system, comprising:
an elevator controller;
an elevator car configured to move between floors of a building in an elevator shaft with the elevator controller, the building comprising:
at least one first floor or at least one first floor area for a first user group; and
at least one second floor or at least one second floor area for a second user group;
wherein an operating mode is assigned to each the first user group, the second user group, the at least one first floor or at least one first floor area and the at least one second floor and at least one second floor area and is saved in a memory device, wherein the elevator controller is configured to control the elevator system in accordance with claim 15.

31. The elevator system of claim 30, wherein the elevator controller is configured to ascertain a call input floor and a destination floor based on an elevator call entered as a destination call outside the elevator car.

32. The elevator system of claim 30, wherein the elevator controller is configured to ascertain a call input floor based on an elevator call entered as a floor call outside the elevator car, wherein the floor call indicates a desired direction of travel.

33. The elevator system of claim 30, wherein the elevator controller is configured to ascertain a destination floor based on an elevator call entered as a car call in the elevator car.

34. The elevator system of claim 30, further comprising elevator operating devices arranged outside the elevator car, wherein the memory device is configured to save for each elevator operating device a user group assigned thereto and the operating mode assigned to this user group.
